(19) United States
(12) Patent Application Publication
(10) Pub. No.: US 2017/0206483 A1
(43) Pub. Date: Jul. 20, 2017

(54) WORKFLOW STORAGE, PROCESSING, MANAGEMENT, AND TASK CREATION SYSTEM

(71) Applicant: Level 3 Communications, LLC, Broomfield, CO (US)

(72) Inventors: John G. Fable, Longmont, CO (US); William Fanselow, Golden, CO (US)

(73) Assignee: Level 3 Communications, LLC, Broomfield, CO (US)

(21) Appl. No.: 14/997,058

(22) Filed: Jan. 15, 2016

(51) Int. Cl. G06Q 10/06

(52) U.S. Cl. CPC G06Q 10/06316

(57) ABSTRACT

Aspects of the present disclosure relate to systems and methods for enabling users to define a workflow, or a set of workflows within an enterprise computing architecture, or enterprise system deployed over a communications network. The workflow may be encapsulated into a standardized data object and transmitted to one or more enterprise resources within the enterprise computing architecture for validation and execution.

### TECHNICAL FIELD

Aspects of the present disclosure relate to the generation and sharing of workflows across an enterprise system.

### BACKGROUND

Communications service providers are constantly offering upgraded or new communications products and services to customers. For example, common services include backbone data and voice transport services, cloud computing services, content delivery and distribution services, and voice over internet protocol services. To provide such services, it is necessary to develop and manage the infrastructural components required to enable the development of the various applications, processes, and/or business functions that allow the providers to offer such products and services to customers. However, many communication service providers, and other providers of communications, networking, video streaming, data and other services, today operate using a variety of heterogeneous computing technologies, business applications, and other resources to perform different business transactions, processes, and/or workflows, and it is often the case that such systems cannot be efficiently replaced or upgraded, due to their complexity, size, and fragmented nature. As the modern economy becomes more technologically complex and business requirements and opportunities change, many businesses will be required to perform new business transactions and workflows that integrate with existing technologies and business systems. Conventional methods for developing such workflows and related technologies may be time-consuming, labor intensive, and expensive because of inconsistent interfaces, fragmented, differently formatted, and/or redundant data sources, and inflexible architectures.

It is with these problems in mind, among others, that various aspects of the present disclosure were conceived.

### SUMMARY

Aspects of the present disclosure include methods, systems, and computer-readable mediums for generating a workflow. The methods, systems, and computer-readable mediums include a memory storing a plurality of tasks, wherein each task of the plurality of tasks implements a specific activity capable of being executed at one or more resources deployed within an enterprise computing architecture. The methods, systems, and computer-readable mediums further include a server, in operable communication with the memory that generates a workflow for execution at one or more of the resources included in the enterprise computing architecture by: generating a graphical user-interface that receives input from a user identifying respective tasks of the plurality of tasks; and generating at least one workflow based on the respective tasks. The methods, systems, and computer-readable mediums include encapsulating the workflow into a standardized data object, wherein the standardized data object is accessible by an application programming interface of at least one resource of the one or more resources. The methods, systems, and computer-readable mediums include initiating an instruction causing execution of the workflow at the at least one resource.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a block diagram illustrating a communications network including an enterprise computing architecture, according to aspects of the present disclosure.

FIG. 2 is a flowchart illustrating an example process for generating workflows, according to aspects of the present disclosure.

FIGS. 3A-3B are block diagrams illustrating a graphical user-interface, according to aspects of the present disclosure.

FIG. 4 is a block diagram illustrating a computing device for performing generating workflows for execution within an enterprise computing architecture, according to aspects of the present disclosure.

### DETAILED DESCRIPTION

Aspects of the present disclosure relate to systems and methods for enabling users to define a workflow, or a set of workflows within an enterprise computing architecture or other enterprise system. A workflow consists of an orchestrated and repeatable pattern of functionality (e.g., business activity) enabled by the systematic organization of computing resources in processes that process information. In various aspects, a workflow management system provides a mechanism (e.g., a graphical user-interface) that allows users to define a workflow by defining a series of independent tasks, each of which perform a different job or process within the enterprise computing architecture. The system combines the independent tasks into a single workflow to provide an orchestrated set of complex business transactions, which may involve processing enterprise data and information within the enterprise computing architecture.

In other aspects, the generated workflows may be encapsulated into a standardized data format interpretable by any machine language and capable of being consumed by multiple and different application programming interfaces. In some embodiments, the application programming interfaces may correspond to various resources included within the enterprise computing architecture, such as management information systems, transaction processing systems, trouble ticketing systems, service applications, inventory resource applications, and/or the like. Regardless of the independent and disparate nature of the application programming interfaces of the resources included in the enterprise computing architecture, each application programming interface is functionally able to consume and process the generated workflows because the workflow has been encapsulated into the standardized data object/format. Thus, the various resources may be used to execute the workflows at the enterprise computing architecture, or enterprise system.

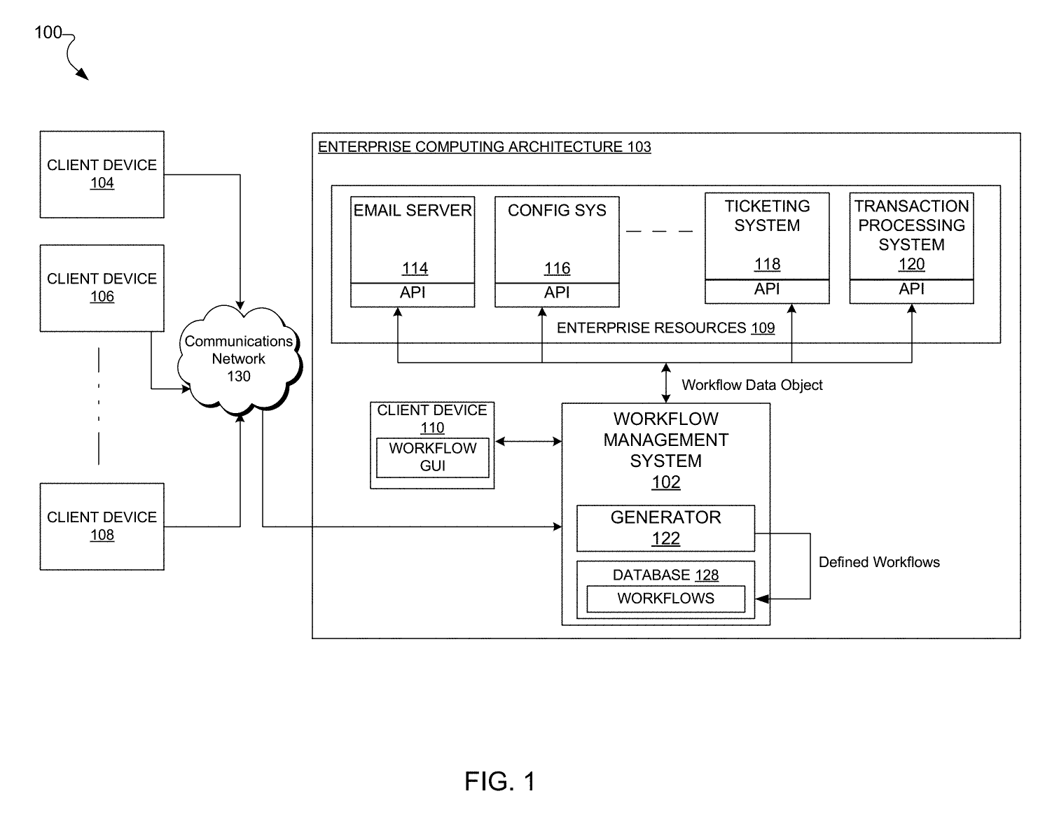

FIG. 1 illustrates an example network 100 comprising a workflow management system 102 for facilitating a generation, standardization, and execution of a workflow within an enterprise computing architecture. The network 100 may be an IP-based telecommunications network, the Internet, an intranet, a local area network, a wireless local network, a content distribution network, or any other type of communications network, as well as combinations of networks. For example, in one particular embodiment, the network 100 may be a telecommunications network including fiber-optic paths between various network elements, such as servers, switches, routers, and/or other optical telecommunications network devices that interconnect to enable receiving and transmitting of information between the various elements as well as users of the network.

According to one embodiment, the workflow management system 102 may be a server that functionally connects (e.g., using communications network 130) one or more client devices 104-110 to various enterprise resources 109 of an enterprise computing architecture 103 included within a network 100. Generally speaking, the resources represent the various computing systems, services, applications, and/or processes that may be employed by an enterprise to perform various business processes and execute various business transactions. In the illustrated embodiment, the enterprise resources include an e-mail server 114, a config system 116, a ticketing system 118, and a transaction processing system 120, among others.

The workflow management system 102 may employ a workflow generator 122 to generate one or more workflows based on input received from the one or more client devices 104-110. In some embodiments, the workflow management system 102 may include a database 128 for storing and retrieving the generated workflows. Although the database 128 of FIG. 1 is depicted as being located within workflow management system 102, it is contemplated that the database 128 may be located external to the workflow management system 102, such as at a remote location, and may communicate with the workflow management system 102. The one or more client devices 104-110 may be any of, or any combination of, a personal computer; handheld computer; mobile phone; digital assistant; smart phone; server; application; and the like. In one embodiment, each of the one or more client devices 104-110 may include a processor-based platform that operates on any suitable operating system, such as Microsoft® Windows®, Linux®, and/or the like that is capable of executing software.

The one or more client devices 104-110 may service the need of users interested in accessing the enterprise resources to perform various business processes and/or transactions. To do so, a user may interact with the one or more of the client device 104-110 and provide input, which may be processed by the work flow generator 122 of the workflow management system 102 to generate one or more workflows. For example, if a user were interested in generating a workflow to decommission a server, as will be further explained below, a user may interact with the one or more client devices 104-110 to identify a series of tasks that are required to be performed in order to properly decommission the server. For example, a workflow to decommission a server may include one or more of the following tasks: Host Validation Unix; Monitoring and Final Backup; Zabbix Maintenance; Final Backup; Scream Test; Backup Removal; System Shutdown Unix; Salt Minion Decomm; Infrastructure Tool Cleanup; Storage Reclaim; Opsware/CMDB Updates Unix; DNS Updates; Load-Balancer Updates; Security (Remedy Ticket); VM/Zone Removal Unix; DataCenter Removal (Remedy Ticket); among others.

The tasks represent separate and distinct portions of functionality that each of the enterprise resources where initially implemented to perform. For example, the ticketing system 118 may include a task that automatically and/or manually generates trouble tickets for communication to other enterprise resources. As another example, the customer service system 116 may include functionality to initialize, upgrade, and/or decommission various hardware and/or software (e.g., the enterprise resources 109) within the enterprise computing architecture 103. In some embodiments, the tasks may be logically arranged to generate a workflow that may be automatically initiated, or user-initiated, at the computing architecture 103 (e.g., actin on the enterprise resources 109), either resulting in the server being automatically decommissioned. Thus, users can interact with the one or more client devices 104-110 to generate one or more workflows for different types of transactions, processes, and/or activities that may be performed within the enterprise computing architecture 103.

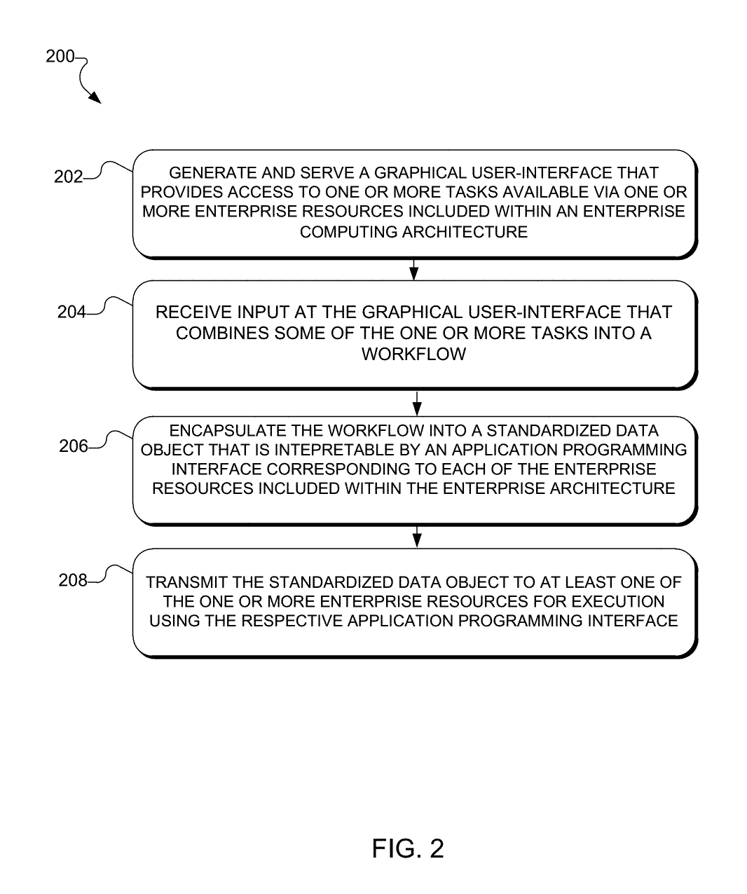

Referring now to FIG. 2 and with reference to FIG. 1, an illustrative process 200 for generating, standardizing, and/or executing a workflow within an enterprise computing architecture is provided. As illustrated, process 200 begins with serving a graphical user-interface that provides access to one or more tasks that are available via a set of computing resources included within an enterprise computing architecture (operation 202). Referring again to FIG. 1, in one embodiment, a graphical user-interface may be generated and/or initialized at the workflow management system 102. Subsequently, the workflow management system 102 may integrate one or more of the tasks, offered by the enterprise resources 109, within the graphical user-interface and provide the graphical user-interface for display to the one or more client devices 104-110. Stated differently, the graphical user-interface may provide various components, buttons, menus, and/or other functions to help the user identify tasks that should be included within a workflow. Referring to the server decommissioning example above, the workflow management system 102 may generate a graphical user-interface that displays the various tasks that may be combined into a workflow, which when executed may automatically cause a server to be decommissioned. In some embodiments, the set of tasks that are supplied within the workflow may are pre-defined and maintained within a database (e.g., the database 128).

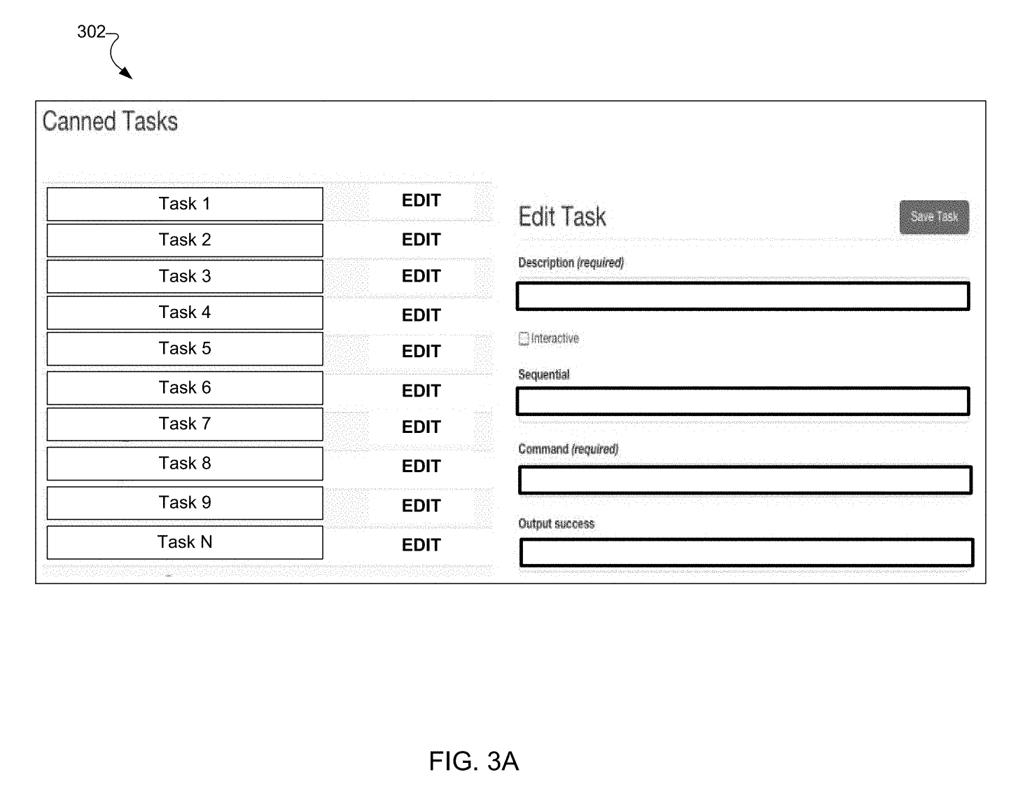

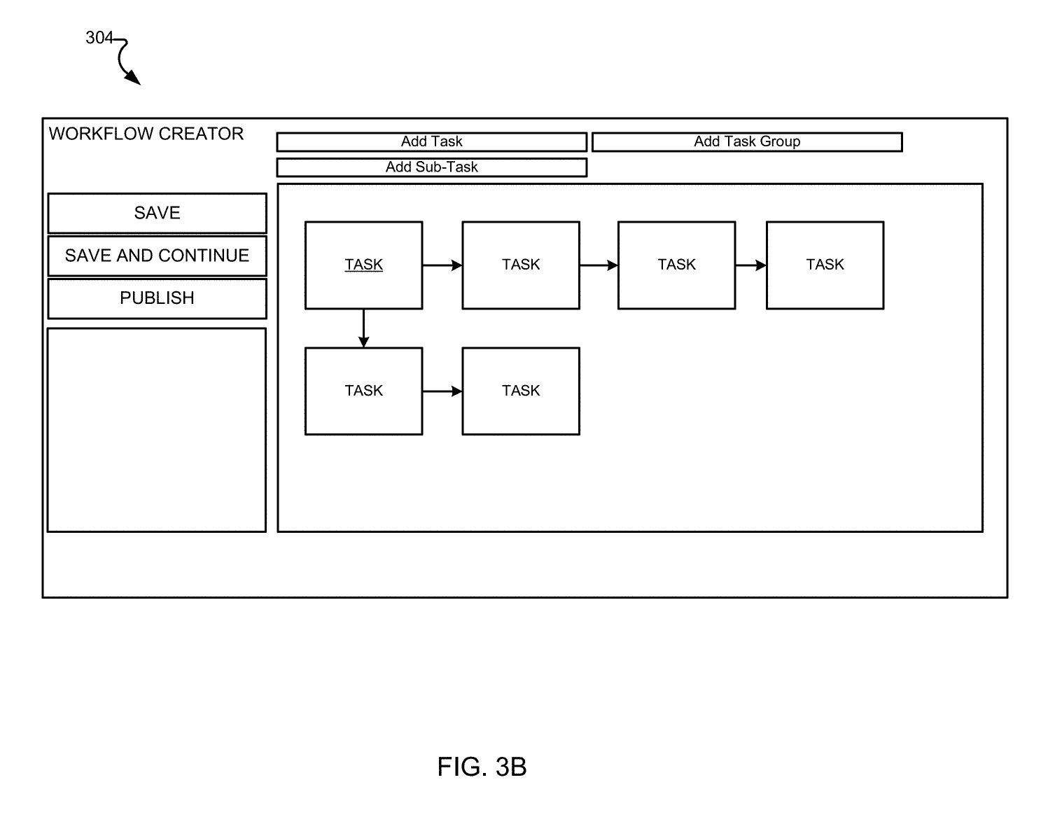

FIGS. 3A-3B provide an example screenshots 302-306 of a graphical-user displaying one or more tasks that may be combined into a workflow. In the current embodiment, the tasks displayed by the graphical user-interface are not arranged in a workflow capable of performing a specific task. Rather, the tasks are displayed in a manner that simply represent the set of tasks available to a user and in a manner that allows the users to see the relationship between different tasks and the various resources included within the enterprise architecture 103. In some embodiments, the tasks may be sorted and/or filtered in a manner that limits some or all of the tasks to specific users. For example, if some users capable of accessing the enterprise system may be allowed to access tasks that other users cannot.

Referring again to FIG. 2, once the graphical user-interface displaying tasks has been generated and displayed to a user, input is received at the graphical user-interface that combines one or more of the tasks into a workflow (operation 204). For example, the input may include a user interacting with a dropdown menu and selecting a one or more tasks that should be included within the workflow. In response, the workflow management system 102 may generate a workflow by combining the selected tasks into a sequential and/or non-sequential ordering of the tasks, arranged in a manner that conforms to rules required by the enterprise computing architecture 103.

In some embodiments, when creating a new workflow, several default parameters may be selected. Such parameters may include parameters corresponding to the type of workflow that is being created (software deploy, server decom, etc.), name and description of the workflow, and basic configurations articulating how to handle specific tasks, for example how to proceed if the task fails, and how many times to retry tasks that fail. For example, in one embodiment, the graphical user-interface displaying tasks may be a “drag and drop” type interface that allows a user to add new task into the workflow and assemble them in any order. Tasks may also be combined into “Groups” that execute everything in the group simultaneously. Some tasks, (e.g., Remedy Ticket Creation) require configuration via workflow parameters that are workflow specific. Alternatively, some tasks do not require parameter configuration and are not able to be edited by a user.

Once a workflow (or workflows) has been generated, the workflow may be encapsulated into a standardized data object that is interpretable by a respective application programming interface corresponding to any one of the enterprise resources included within the enterprise computing architecture (operation 206). Referring to FIG. 1, each enterprise resource 109 may include an application programming interface (“API”) that includes or otherwise defines various routines, protocols, and tools for performing various activities at the respective enterprise resource. For example and as explained above, the ticketing system 116 may include an API that includes functionality for generating and queuing trouble tickets. As another example, the config system 118 may include an API that defines functionality for verifying whether a hardware component, such as a server, is online or offline. The standardized data object encapsulating the workflow may be consumed or otherwise processed by any one of such APIs corresponding to any one of the enterprise resources 109 included within the enterprise architecture 103, even though the APIs of each resource may be different. Moreover, no changes need to be made to the existing APIs to enable the processing of the standardized data object. Thus, encapsulating the workflow in a standardized data object format allows the workflow to be processed and/or consumed by different and multiple APIs associated with the enterprise resources 109.

In one embodiment, the workflow may be encapsulated within a Javascript Object Notation® (“JSON”) data object. Generally speaking, JSON represents a lightweight, text-based syntax standard used for serializing and transmitting structured data over network connection. JSON involves a self-describing syntax that may be interpreted by applications that do not already know what to expect when processing the JSON object.

Referring to the server decommissioning example provided above, the following JSON object may be generated that encapsulates one or more of the tasks included in the workflow generated to decommission the server. The following is an example JSON object for decommissioning a server, according to one embodiment:

```
{
  “workflow_name”:“server_decom_unix”,
  “workflow_descr”:“Decommission Unix Server”,
  “task_info_cmd”:“https://protect-us.mimecast.com/s/ZpkOBVlk7mgYFZ”,
  “task_timeout_hrs”:0,
  “task_retries”:1,
  “interactive”:0,
  “sequential”:1,
  “task_output_success”:{
```

“regex”:“caseID=HD(\\d+)”,
“op”:“~”,
“value”:“caseID=HD(\\d+)”

```
  },
  “task_status_cmd”:“/app/iap/WORKFLOWS/bin/getRemedyCaseStatus.pl +&getTaskOutput( )”,
  “task_status_success”:{
```

“regex”:“Status=(.*)”,
“split”:“=”,
“field”:2,
“op”:“~”,
“value”:“(Resolved|Closed)”

```
  },
  “task_list”:[
```

```
{
  “task_descr”:“Host Validation Unix”,
  “task_cmd”:“/app/iap/WORKFLOWS/bin/submitRemedyTicket.pl -category \”UNIX Server
```

Administration\“ -type \”Decommission\“ -item \”Decommission\“ -assignedGroup \”UNIX Arch
Support\“ -requestorLogin _{——}requestor_{——} -summary \”request_id=_{——}request_id_{——}
_{——}server_name_{——}\“ -description \”_{——}server_name_{——} DECOM: Host Validation. For guidance
see: https://protect-us.mimecast.com/s/mmoeBWUq8LoDiD“ ”,

```
  “sequential”:1,
  “interactive”:1
},
{
  “task_descr”:“Monitoring and Final Backup”,
  “task_group”:[
```

```
{
  “task_descr”:“Zabbix Maintenence”,
  “task_cmd”:“/app/iap/WORKFLOWS/bin/submitRemedyTicket.pl -category \”Infrastructure
```

Support\“ -type \”Decommission\“ -item \”Decommission\“ -assignedGroup \”Infrastructure
Support\“ -requestorLogin _{——}requestor_{——} -summary \”request_id=_{——}request_id_{——}
_{——}server_name_{——}\“ -description \”_{——}server_name_{——} DECOM: Zabbix Maintenance for Decom
Process\“ ”,

```
  “sequential”:0,
  “interactive”:0
},
{
  “task_descr”:“Final Backup”,
  “task_cmd”:“/app/iap/WORKFLOWS/bin/submitRemedyTicket.pl -category \”Netbackup\“
```

-type \”Administration\“ -item \”Deactivate Backup\“ -assignedGroup \”Backup Operations\“ -
requestorLogin _{——}requestor_{——} -summary \”request_id=_{——}request_id_{——} _{——}server_name_{——}\“ -
description \”_{——}server_name_{——} DECOM: Perform final full backup and keep in backup
Infrastructure during scream test cycle\“ ”,

```
  “sequential”:0,
  “interactive”:0
}
```

```
  ]
},
{
  “task_descr”:“Scream Test”,
  “task_cmd”:“/app/iap/WORKFLOWS/bin/submitRemedyTicket.pl -category \”Infrastructure
```

Support\“ -type \”Decommission\“ -item \”Decommission\“ -assignedGroup \”Infrastructure
Support\“ -requestorLogin _{——}requestor_{——} -summary \”request_id=_{——}request_id_{——}
_{——}server_name_{——}\“ -description \”_{——}server_name_{——} DECOM: See Resolution-Summary of
Host-Validation ticket for scream-test instructions.\“ ”,

```
  “sequential”:1,
  “interactive”:1
},
{
  “task_descr”:“Backup Removal”,
  “task_cmd”:“/app/iap/WORKFLOWS/bin/submitRemedyTicket.pl -category \”Netbackup\“ -
```

type \”Administration\“ -item \”Deactivate Backup\“ -assignedGroup \”Backup Operations\“ -
requestorLogin _{——}requestor_{——} -summary \”request_id=_{——}request_id_{——} _{——}server_name_{——}\“ -
description \”_{——}server_name_{——} DECOM: Remove from Backups\“ ”,

```
  “sequential”:1,
  “interactive”:0
},
{
  “task_descr”:“System Shutdown Unix”,
  “task_cmd”:“/app/iap/WORKFLOWS/bin/submitRemedyTicket.pl -category \”UNIX Server
```

Administration\“ -type \”Decommission\“ -item \”Decommission\“ -assignedGroup \”UNIX Arch
Support\“ -requestorLogin _{——}requestor_{——} -summary \”request_id=_{——}request_id_{——}
_{——}server_name_{——}\“ -description \”_{——}server_name_{——} DECOM: Shutdown the System\“ ”,

```
  “sequential”:1,
  “interactive”:0
},
{
  “task_descr”:“Salt Minion Decomm”,
  “task_cmd”:“/usr/bin/ssh -i /var/www/.ssh/id_rsa iapportal@buildserver2.idc1.level3.com
```

‘sudo /spacewalk/scripts/salt/decomm_minion _{——}server_name_{——}’”,

```
  “sequential”:0,
  “interactive”:0,
  “task_output_success”:0
},
{
  “task_descr”:“Infrastructure Tool Cleanup”,
  “task_group”:[
```

```
{
  “task_descr”:“Storage Reclaim”,
  “task_cmd”:“/app/iap/WORKFLOWS/bin/submitRemedyTicket.pl -category \”SAN
```

Storage\“ -type \”Request\“ -item \”Reclaim\“ -assignedGroup \”Data Storage\“ -requestorLogin
_{——}requestor_{——} -summary \”request_id=_{——}request_id_{——} _{——}server_name_{——}\“ -description
\”_{——}server_name_{——} DECOM: Storage Reclaim\“ ”,

```
  “sequential”:0,
  “interactive”:0
},
{
  “task_descr”:“Opsware/CMDB Updates Unix”,
  “task_cmd”:“/app/iap/WORKFLOWS/bin/submitRemedyTicket.pl -category \”UNIX Server
```

Administration\“ -type \”Decommission\“ -item \”Decommission\“ -assignedGroup \”UNIX Arch
Support\“ -requestorLogin _{——}requestor_{——} -summary \”request_id=_{——}request_id_{——}
_{——}server_name_{——}\“ -description \”_{——}server_name_{——} DECOM: Remove system from
Opsware/CMDB\“ ”,

```
  “sequential”:0,
  “interactive”:0
},
{
  “task_descr”:“DNS Updates”,
  “task_cmd”:“/app/iap/WORKFLOWS/bin/submitRemedyTicket.pl -category \”Network
```

Operations/IPand DS\“ -type \”DNS/IP/Port Activation\“ -item \”Delete\“ -assignedGroup
\”System Ops Engineering\“ -requestorLogin _{——}requestor_{——} -summary
\”request_id=_{——}request_id_{——} _{——}server_name_{——}\“ -description \”_{——}server_name_{——} DECOM:
DNS Cleanup\“ ”,

```
  “sequential”:0,
  “interactive”:0
},
{
  “task_descr”:“Load-Balancer Updates”,
  “task_cmd”:“/app/iap/WORKFLOWS/bin/submitRemedyTicket.pl -category \”Environment
```

Support\“ -type \”Request\“ -item \”Other\“ -assignedGroup \”ENV Arch Support\“ -
requestorLogin _{——}requestor_{——} -summary \”request_id=_{——}request_id_{——} _{——}server_name_{——}\“ -
description \”_{——}server_name_{——} DECOM: Netscaler Cleanup\“ ”,

```
  “sequential”:0,
  “interactive”:0
},
{
```

“task_descr”:“Security (Remedy Ticket)”,
“task_cmd”:“/app/iap/WORKFLOWS/bin/submitRemedyTicket.pl -category Firewalls -type
Other -item Change -assignedGroup \”NetSecurity/Global\“ -requestorLogin _{——}requestor_{——} -
summary \”request_id=_{——}request_id_{——} _{——}server_name_{——}\“ -description \”_{——}server_name_{——}
DECOM: Remove from Symantec; Firewall Rule Cleanup. ip-list=##ip_address_list## Check
for other IPs in ITVIEW.\“ ”,

```
  “sequential”:1,
  “interactive”:0
}
```

```
  ]
},
{
  “task_descr”:“VM/Zone Removal Unix”,
  “task_cmd”:“/app/iap/WORKFLOWS/bin/submitRemedyTicket.pl -category \”UNIX Server
```

Administration\“ -type \”Decommission\“ -item \”Decommission\“ -assignedGroup \”UNIX Arch
Support\“ -requestorLogin _{——}requestor_{——} -summary \”request_id=_{——}request_id_{——}
_{——}server_name_{——}\“ -description \”_{——}server_name_{——} DECOM: VM/Zone Removal\“ ”,

```
  “sequential”:1,
  “interactive”:0
},
{
  “task_descr”:“DataCenter Removal (Remedy Ticket)”,
  “task_cmd”:“/app/iap/WORKFLOWS/bin/submitRemedyTicket.pl -category
```

_{——}datacenter_category_{——} -type _{——}datacenter_type_{——} -item _{——}datacenter_item_{——} -
assignedGroup _{——}assigned_group_{——} -requestorLogin _{——}requestor_{——} -summary
\”request_id=_{——}request_id_{——} _{——}server_name_{——}\“ -description \”##server_name## DECOM:
Hardware Removal: Location=##location## MakeModel=##make_model_version##
SerialNum=##serialnum##\“ ”,

```
  “sequential”:1,
  “interactive”:0
}
```

]
}

Once a JSON element has been created, the management server 102 may compare the generated JSON object containing the workflow to a JSON object master template, stored in the database 128, to verify that the workflow has properly defined all of the required properties and attributes. For example, in one embodiment, the JSON master template may define a JSON key as being required or optional and defines the range of values allowed for each key. If a JSON object contains an appropriate key value, when compared to the key of the JSON master template the JSON object is considered to be verified and valid. Although the above example refers to JSON, it is contemplated that other standardized data object formats may be used, such as Extensible Markup Language (“XML”) Hypertext Markup Language (“HTML”) Snippets, and/or the like.

Referring again to FIG. 2, the generated standardized data object containing the workflow is transmitted to any one of the enterprise computer resources included within the enterprise architecture for execution (operation 208). Referring to FIG. 1, the workplace management system 102 may transmit the standardized data object to one of the resources 109 included within the enterprise architecture 112 for processing. The processing of the workflow may occur automatically at the enterprise resource that received the JSON object, or in response to user input provided to a graphical user-interface. Stated differently, any of the generated workflows may be stored in the database 128 for later retrieval. In such an embodiment, a user may interact with a graphical user-interface that allows the user to select the workflow and initiate execution. In response, the workflow is encapsulated into a JSON object and transmitted to one or more of the enterprise resources 109 for execution.

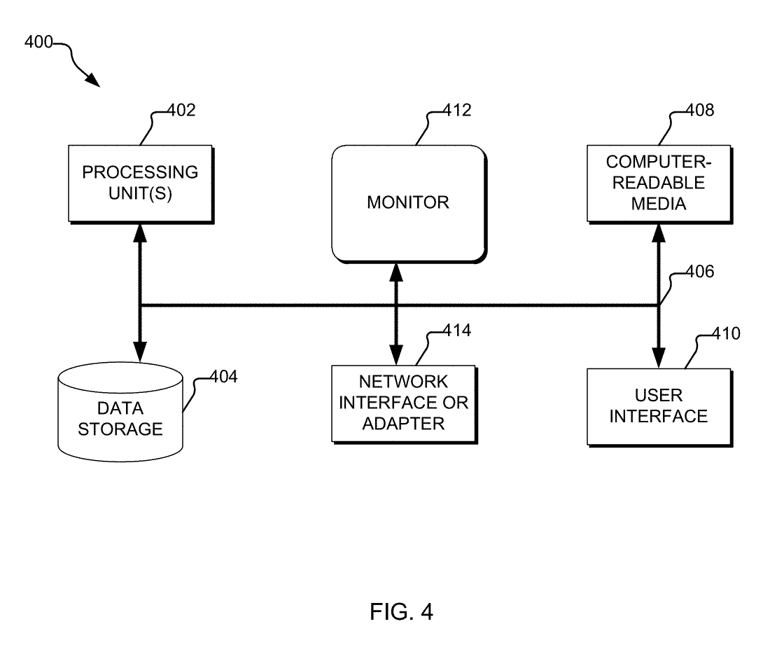

FIG. 4 illustrates an example of a suitable computing and networking environment 400 that may be used to implement various aspects of the present disclosure described in FIGS. 1-3A and 3B. As illustrated, the computing and networking environment 400 includes a general purpose computing device 400, although it is contemplated that the networking environment 400 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 400 may include various hardware components, such as a processing unit 402, a data storage 404 (e.g., a system memory), and a system bus 406 that couples various system components of the computer 400 to the processing unit 402. The system bus 406 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 400 may further include a variety of computer-readable media 408 that includes removable/non-removable media and volatile/nonvolatile media, but excludes transitory propagated signals. Computer-readable media 408 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 400. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 404 includes computer storage media in the form of volatile/nonvolatile memory such as read only memory (ROM) and random access memory (RAM). A basic input/output system (BIOS), containing the basic routines that help to transfer information between elements within the computer 400 (e.g., during start-up) is typically stored in ROM. RAM typically contains data and/or program modules that are immediately accessible to and/or presently being operated on by processing unit 402. For example, in one embodiment, data storage 404 holds an operating system, application programs, and other program modules and program data.

Data storage 404 may also include other removable/non-removable, volatile/nonvolatile computer storage media. For example, data storage 404 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 4, provide storage of computer-readable instructions, data structures, program modules and other data for the computer 400.

A user may enter commands and information through a user interface 410 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 402 through a user interface 410 that is coupled to the system bus 406, but may be connected by other interface and bus structures, such as a parallel port, game port or a universal serial bus (USB). A monitor 412 or other type of display device is also connected to the system bus 406 via an interface, such as a video interface. The monitor 412 may also be integrated with a touch-screen panel or the like.

The computer 400 may operate in a networked or cloud-computing environment using logical connections of a network interface or adapter 414 to one or more remote devices, such as a remote computer. The remote computer may be a personal computer, a server, a router, a network PC, a peer device or other common network node, and typically includes many or all of the elements described above relative to the computer 400. The logical connections depicted in FIG. 4 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 400 may be connected to a public and/or private network through the network interface or adapter 414. In such embodiments, a modem or other means for establishing communications over the network is connected to the system bus 406 via the network interface or adapter 414 or other appropriate mechanism. A wireless networking component including an interface and antenna may be coupled through a suitable device such as an access point or peer computer to a network. In a networked environment, program modules depicted relative to the computer 400, or portions thereof, may be stored in the remote memory storage device.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A system for generating a workflow comprising:
a memory storing a plurality of tasks, wherein each task of the plurality of tasks implements a specific activity capable of being executed at one or more resources deployed within an enterprise computing architecture; and
a server, in operable communication with the memory that generates a workflow for execution at one or more of the resources included in the enterprise computing architecture by:
generating a graphical user-interface that receives input from a user identifying respective tasks of the plurality of tasks;
generating at least one workflow based on the respective tasks;
encapsulating the workflow into a standardized data object, wherein the standardized data object is accessible by an application programming interface of at least one resource of the one or more resources; and
initiating an instruction causing execution of the workflow at the at least one resource.

2. The system of claim 1, wherein encapsulating the workflow into a standardized data object comprises encapsulating the workflow into a JavaScript Object Notation (“JSON”) object.

3. The system of claim 1, wherein the respective tasks includes first and second tasks, wherein the graphical user interface includes interactive menu components that allows users to graphically identify the first and second tasks by selecting a first graphical element corresponding to the first task and a second graphical element corresponding to the second task, and wherein the first task and second task represent first and second tasks of the workflow.

4. The system of claim 3, wherein initiating the instruction is in response to the user manipulating an element of the graphical user-interface to cause the server to initiate the instruction after the workflow has been generated, and wherein initiating the instruction comprises:
processing the standardized data object using the application programming interface to access data corresponding to the workflow.

5. The system of claim 1, wherein each task of the plurality of tasks represents a business activity and wherein the one or more resources is at least one of an email server, a repair automation system, a configuration management system, and a ticketing system.

6. The system of claim 1, further comprising verifying that the standardized data object is acceptable by matching the standardized data object to a master JSON object template.

7. A method for generating a workflow comprising:
generating a workflow for execution at one or more of resources included in an enterprise computing architecture by:
generating a graphical user-interface that receives input from a user identifying respective tasks of a plurality of tasks, wherein each task of the plurality of tasks implements a specific activity capable of being executed at the one or more resources deployed within the enterprise computing architecture;
generating at least one workflow based on the identified respective tasks;
encapsulating the workflow into a standardized data object, wherein the standardized data object is accessible by an application programming interface of at least resource of the one or more resources; and
initiating an instruction causing execution of the workflow at the at least one resource.

8. The method of claim 7, wherein encapsulating the workflow into a standardized data object comprises encapsulating the workflow into a JavaScript Object Notation (“JSON”) object.

9. The method of claim 7, wherein the respective tasks include first and second tasks, wherein the graphical user interface includes interactive menu components that allows users to graphically identify the first and second tasks by selecting a first graphical element corresponding to the first task and a second graphical element corresponding to the second task, and wherein the first task and second task represent first and second tasks of the workflow.

10. The method of claim 9, wherein initiating the instruction is in response to the user manipulating an element of the graphical user-interface to cause the server to initiate the instruction after the workflow has been generated, and wherein initiating the instruction comprises:
processing the standardized data object using the application programming interface to access data corresponding to the workflow.

11. The method of claim 7, wherein each task of the plurality of tasks represents a business activity and wherein the one or more resources is at least one of an email server, a repair automation system, a configuration management system, and a ticketing system.

12. The method of claim 7, further comprising verifying that the standardized data object is acceptable by matching the standardized data object to a master JSON object template.

13. A non-transitory computer-readable medium encoded with instructions for generating a workflow, the instructions executable by a processing device, comprising:
generating a workflow for execution at one or more of resources included in an enterprise computing architecture by:
generating a graphical user-interface that receives input from a user identifying respective tasks of a plurality of tasks, wherein each task of the plurality of tasks implements a specific activity capable of being executed at the one or more resources deployed within the enterprise computing architecture;
generating at least one workflow based on the identified respective tasks;
encapsulating the workflow into a standardized data object, wherein the standardized data object is accessible by an application programming interface of at least one resource of the one or more resources; and
initiating an instruction causing execution of the workflow at the at least one resource.

14. The non-transitory computer-readable medium of claim 13, wherein encapsulating the workflow into a standardized data object comprises encapsulating the workflow into a JavaScript Object Notation (“JSON”) object.

15. The non-transitory computer-readable medium of claim 13, wherein the respective tasks includes a first and second tasks, wherein the graphical user interface includes interactive menu components that allows users to graphically identify the first and second tasks by selecting a first graphical element corresponding to the first task and a second graphical element corresponding to the second task, and wherein the first task and second task represent first and second tasks of the workflow.

16. The non-transitory computer-readable medium of claim 15, wherein initiating the instruction is in response to the user manipulating an element of the graphical user-interface to cause the server to initiate the instruction after the workflow has been generated, and wherein initiating the instruction comprises:
processing the standardized data object using the application programming interface to access data corresponding to the workflow.

17. The non-transitory computer-readable medium of claim 13, wherein each task of the plurality of tasks represents a business activity and wherein the one or more resources is at least one of a customer management system, repair automation system, configuration management system, and ticketing system.

18. The non-transitory computer-readable medium of claim 13, further comprising verifying that the standardized data object is acceptable by matching the standardized data object to a master JSON object template.
